(19) United States
(12) Patent Application Publication
(10) Pub. No.: US 2020/0160245 A1
(43) Pub. Date: May 21, 2020

(54) VEHICLE PRODUCTION AND DISTRIBUTION SYSTEM FOR RIDE SHARE PROGRAMS AND METHOD THEREOF

(71) Applicant: Honda Motor Co., Ltd., Tokyo (JP)

(72) Inventor: Kiyotaka KAWASHIMA, Los Angeles, CA (US)

(21) Appl. No.: 16/192,636

(22) Filed: Nov. 15, 2018

(51) Int. Cl. G06Q 10/06; G06Q 30/02; G06Q 50/04; G06Q 50/30; G08G 1/00; G01C 21/34; G07C 5/00

(52) U.S. Cl. CPC G06Q 10/06315; G06Q 30/0202; G06Q 50/04; G07C 5/008; G08G 1/20; G01C 21/3438; G06Q 50/30

(57) ABSTRACT

In an illustrative embodiment, a vehicle production system is provided that communicates with a plurality of vehicles through a network. The plurality of vehicles may provide trip information to the system. The trip information may include locations of stops. Patterns may be identified through the locations of the stops for the plurality of vehicles. Based on these patterns, the system may determine whether vehicles within the plurality of vehicles are for ride share. This determination may be used for producing or manufacturing new vehicles.

### BACKGROUND

In a vehicle production line management system, different models may be manufactured on an identical line for an efficiency of vehicle production. Various vehicle models may use a variety of parts that are different from one another. This may be true for vehicles produced for ride share programs, that is, vehicles that may be used in which a passenger travels in a vehicle driven by its owner, for free or a fee, as arranged by means of a website or application.

Some vehicles produced for ride share programs may incorporate different materials. These vehicles may include seat materials that are more durable and harder to destroy in passenger seats. Rear vehicle doors, and their associated mechanisms, may also be constructed differently from vehicles used for ride share programs. For example, the mechanisms may prevent passengers from entering or exiting from the vehicle.

Unfortunately, current vehicle production line management systems have found difficulties in estimating production needs for vehicles that may be used for ride share programs, and those that are not. The present disclosure provides for a vehicle production and distribution system for ride share programs and method thereof that addresses the above-identified concerns. Other benefits and advantages will become clear from the disclosure provided herein and those advantages provided are for illustration. The statements in this section merely provide the background related to the present disclosure and does not constitute prior art.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a vehicle production system is provided. The system may include a communication network, at least one processor, and a memory operatively coupled to the processor, the memory storing program instructions that when executed by the processor, causes the processor to perform processes. These processes may include receiving locations of stops from a plurality of vehicles through the communication network, identifying patterns through the locations of the stops for the plurality of vehicles, determining whether vehicles within the plurality of vehicles are for ride share based on the patterns, and producing a number of new vehicles for ride share based on the determination.

In accordance with another aspect of the present disclosure, a method of identifying a ride share vehicle is provided. The method may include determining locations of stops for a vehicle and associating the vehicle as a ride share vehicle when the locations of the stops for the vehicle are irregular and a time at the stops are below a predetermined threshold

In accordance with yet another aspect of the present disclosure, a vehicle production and distribution system is provided. The system may include a plurality of vehicles providing locations of stops. In addition, the system may include a server receiving the locations of the stops for the plurality of vehicles and associating the plurality of vehicles as ride share vehicles when the locations of the stops are irregular and a time at the stops are below a predetermined threshold, the server taking ratios of ride share vehicles to non-ride share vehicles and generating production orders and schedules.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a schematic diagram of an illustrative scenario where vehicles may be monitored to determine production requirements in accordance with one aspect of the present disclosure;

FIG. 2 is a schematic diagram of an illustrative vehicle showing components that may be used for monitoring the vehicle in accordance with one aspect of the present disclosure;

FIG. 3 is a schematic diagram of an illustrative table showing miles per year for a plurality of vehicles within an urban and rural environment to determine whether the vehicles are in a ride share program in accordance with one aspect of the present disclosure;

FIG. 4 is a schematic diagram of an illustrative vehicle showing routes taken by the vehicle that may demonstrate that the vehicle is not in a ride share program in accordance with one aspect of the present disclosure;

FIG. 5 is a schematic diagram of an illustrative vehicle showing routes taken by the vehicle that may demonstrate that the vehicle is in a ride share program in accordance with one aspect of the present disclosure;

FIG. 6 is a schematic diagram of an illustrative vehicle showing aggressive and non-aggressive behavior taken by the vehicle that may demonstrate that the vehicle is in a ride share program in accordance with one aspect of the present disclosure;

FIG. 7 is a schematic diagram of an illustrative vehicle showing time taken at different stops that may demonstrate that the vehicle is in a ride share program in accordance with one aspect of the present disclosure; and

FIG. 8 is a schematic diagram of an illustrative flow chart showing factors that may be used to determine whether a vehicle is in a ride share program in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

Generally described, a system is presented that identifies vehicles that may be used for ride share programs and using that information, producing and distributing vehicles to dealerships that are made for such ride share programs. In an illustrative embodiment, a vehicle production and distribution system for ride share programs is provided that communicates with a plurality of vehicles through a network. The plurality of vehicles may provide trip information to the system. The trip information may include locations of stops. Patterns may be identified through the trip information and locations of the stops. Based on these patterns, the system may determine whether vehicles within the plurality of vehicles are for ride share. This determination may be used for producing or manufacturing new vehicles.

Numerous other modifications or configurations to the vehicle production and distribution system for ride share programs will become apparent from the description provided below. While trip information along with stops may be used to determine patterns, routes may also be identified and used. These routes may not be defined by the stops taken, rather the paths that are used to get to the stops. Stops may be defined, but not necessarily limited to, when the driver arrives at a pickup location. This does not necessarily include an ignition off nor standing still at the location. For example, a stop may include a slowly inching up of the vehicle to look for the requestor.

Advantageously, new vehicles adapted to ride share programs may be produced or manufactured using this system. The system may account for changing purchase habits of customers. This system may allow for specific parts to be pre-ordered and aligned with those vehicle production line management systems. A better more streamlined process may be enabled when parts for certain models may be defined based on customer needs. Other advantages will become apparent from the description provided below.

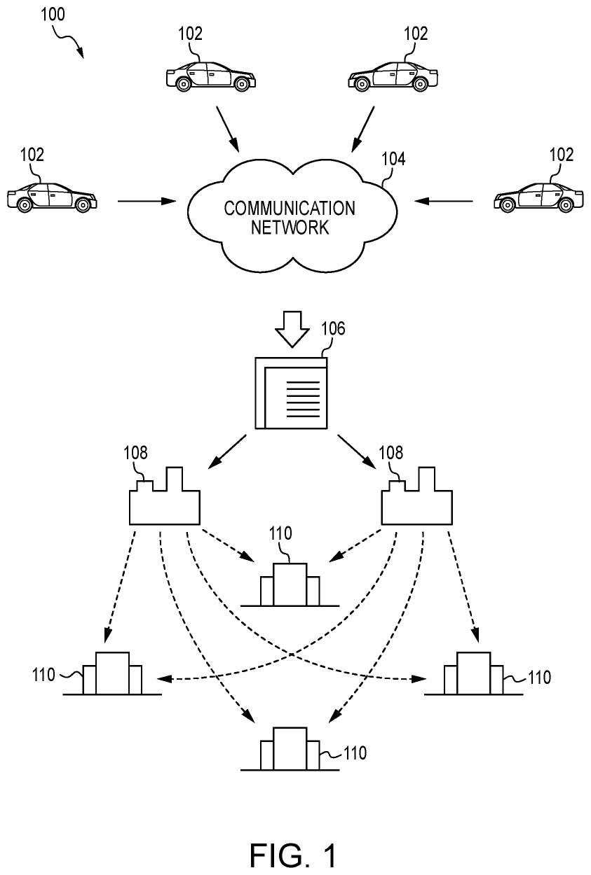

Turning to FIG. 1, a schematic diagram of an illustrative scenario 100 where vehicles 102 may be monitored to determine production requirements in accordance with one aspect of the present disclosure is provided. The vehicle production and distribution system 106 may be the centerpiece where information is processed and production orders and schedules generated. Other configurations may be implemented such that processing may take place on different components within the scenario 100. For example, some of the information may be processed on the vehicles 102, factories 108, or dealerships 110.

The vehicle production and distribution system 106 may include, but is not limited to, a communication unit, input unit, output unit, processor unit, and memory unit to generate production orders and schedules. These may be embodied in a server or the like. The communication unit may include one or more units allowing wireless or wireline communications between the communication network 104 and factories 108. Furthermore, the communication unit may provide communications with the dealerships 108. The communication unit may include at least one of a broadcast receiver, a mobile communication unit, a wireless Internet unit, a short-range communication unit, a location information unit or the like.

As discussed, the system 106 may communicate with a communication network 104. The communication network 104 may include, for example, a local-area network (LAN), the Internet, intranet, wide-area network (WAN), personal-area network (PAN), campus-area network (CAN), metropolitan area network (MAN), global-area network (GAN), virtual private network, or any other type of network supporting communication between devices described herein. The network 104 may include both wired and wireless connections, including optical links. Data and other information may be distributed from the system 106 to and from the vehicle 102 through the communication network 104.

After processing the information, the vehicle production and distribution system 106 may generate and send production orders and schedules to the factories 108. The factories 108 may specialize in one component or assemble all components of the vehicle 102. At the factories 108, an assembly line may be used to construct the vehicles 102. Components may be added as the semi-finished vehicle 102 moves from workstation to workstation until the final assembly is produced. By mechanically moving the parts through the assembly and moving the semi-finished assembly from work station to work station, a finished product may be assembled faster and with less labor than by having workers carry parts to a stationary piece for assembly.

The vehicles 102, after distributed from the factories 108, may be provided to a plurality of dealerships 110. The vehicles 102 may be distributed to the dealerships 110 through a variety of transport vehicles including train, carrier, ship or the like. Through the vehicle production and distribution system 106, vehicles 102 may be produced according to consumer demands, that is, whether vehicle owners or drivers are using the vehicles 102 for ride share programs or not.

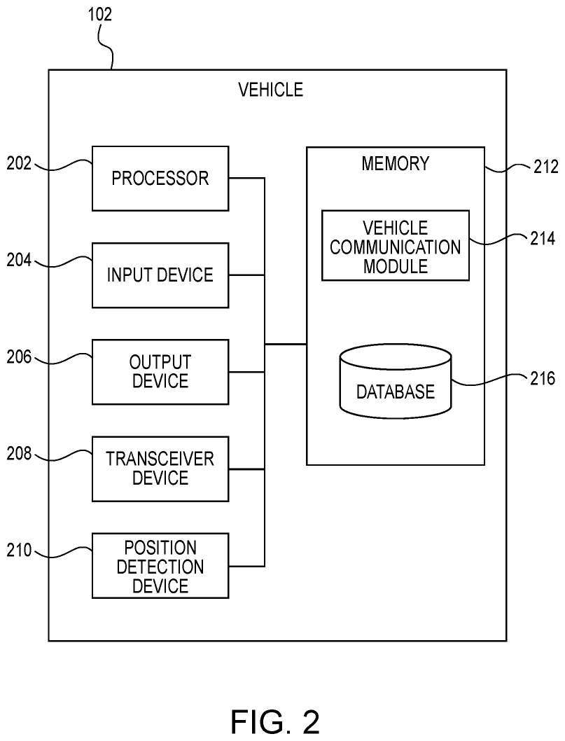

FIG. 2 is a schematic diagram of an illustrative vehicle 102 showing components that may be used for monitoring the vehicle 102 in accordance with one aspect of the present disclosure. By monitoring vehicle information, the vehicle production and distribution system 106 may be able to determine whether the vehicle 102 is being used for ride share purposes. As discussed, stop locations may be used as well as routes. Other types of information may be used to determine whether the vehicle 102 is being used for ride share programs which will become apparent from the discussion provided below.

The vehicle 102 may include, but is not limited to, a processor 202, an input device 204, an output device 206, a transceiver device 208, a position detection device 210, and a memory 212. These components may exist within a telematics device or other area of the vehicle 102. Furthermore, these components may be within the same area of the vehicle 102 or distributed on or off the vehicle 102. In some implementations, all or a portion of these components may be tied to a personal device such as a smartphone where the processing may take place.

The processor 202 may process data signals and may include various computing architectures including a complex instruction set computer (CISC) architecture, a reduced instruction set computer (RISC) architecture, or an architecture implementing a combination of instruction sets. Although only a single processor is shown, multiple processors may be included. The processor 202 may include an arithmetic logic unit, a microprocessor, a general purpose computer, or some other information appliance equipped to transmit, receive and process electronic data signals from the memory 212, the input device 204, the output device 206, the transceiver device 208 or the position detection device 210.

The input device 204 may be any device configured to provide user input to the vehicle 102. This input may come into a telematics device. Such input devices 204 may include a cursor controller or a keyboard. In one embodiment, the input device 204 may include an alphanumeric input device, such as a QWERTY keyboard, a key pad or representations of such created on a touch screen, adapted to communicate information and/or command selections to the processor 202 or memory 212.

In another embodiment, the input device 204 may be a user input device equipped to communicate positional data as well as command selections to processor 202 such as a joystick, a mouse, a trackball, a stylus, a pen, a touch screen, cursor direction keys or other mechanisms to cause movement adjustment of an image. The input device 204 may be part of a personal device such as a smartphone. The input device 204 may provide navigation instructions, such as a destination that the vehicle is going to go to. Locations may be received through the input device 204. This may be part of a separate program associated with a ride share program. The program may be provide input on stops, locations, customer information, or the like.

The output device 206 may represent any device equipped to display electronic images and data as described herein. Output device 206 may be, for example, an organic light emitting diode display (OLED), liquid crystal display (LCD), cathode ray tube (CRT) display, or any other similarly equipped display device, screen or monitor. In one embodiment, the output device 206 may be equipped with a touch screen in which a touch-sensitive, transparent panel covers the screen of output device 206. In one embodiment, the output device 206 may be equipped with a speaker that outputs audio. The output device 206 may be part of the personal device.

The transceiver device 208 may represent a device that allows the vehicle 102 to communicate with entities via the communication network 104. The transceiver device 208 may be used by the vehicle 102 to communicate with the vehicle production and distribution system 106. Although a single transceiver device 208 is shown, it should be understood that the vehicle 102 may include multiple transceiver devices. For example, one transceiver device 208 may be configured to communicate via the wireless communication network and another transceiver device may be configured to communicate via that short range protocol. In one embodiment, the transceiver device 208 is for one or more of the following communications: infrared communication, IEEE 802.11a/b/g/n/p communication, 3/4/5 G communications, 3GPP Long Term Evolution (LTE), IEEE 802.16 (or WiMax) communication, or radio frequency communication.

In one embodiment, the short range wireless communication protocol is Bluetooth® and the transceiver device 208 is used for Bluetooth® communication. The communication range of the transceiver device 208 via Bluetooth® may be limited. Typically the communication range via Bluetooth® is between one (1) meter and one hundred (100) meters depending on the transceiver device 208. The transceiver device 208 may communicate via Bluetooth® with devices with which it has established a connection. A connection with a device may last as long as the device is within range or until one of the devices terminates the connection.

The position detection device 210 may represent a device that communicates with a plurality of positioning satellites (e.g., GPS satellites) to determine the geographical location of the vehicle 102. In one embodiment, to determine the location of the vehicle 102, the position detection device 210 may search for and collect GPS information or signals from four or more GPS satellites that are in view of the position detection device 210. Using the time interval between the broadcast time and reception time of each signal, the position detection device 210 may calculate the distance between the vehicle 102 and each of the four or more GPS satellites. These distance measurements, along with the position and time information received in the signals, may allow the position detection device 210 to calculate the geographical location of the vehicle 102.

In one embodiment, the position device 210 may be separate from the vehicle 102 and placed on the personal device. The personal device may be a personal computer, a laptop computer, smartphone, personal digital assistant (PDA), combination mobile telephone/PDA, gaming device, messaging device, media player, pager, tablet computer, or a netbook computer, for example. Different variations of the position device 210 on the personal device may be used to determine a location or position such as pinning the location at a Wi-Fi access point.

By detecting positions of the vehicle 102, and/or personal device, routes, paths, stopping locations, or the like may be determined. Real-time tracking information may be maintained by the vehicle 102 or personal device, or remotely therefrom on the vehicle production and distribution system 106. Coordinates along with times that the vehicle 102 or personal device may be maintained or stored.

The memory 212 may store instructions and/or data that may be executed by the processor 202. The instructions and/or data may include code for performing any and/or all of the techniques described herein. The memory 212 may be a dynamic random access memory (DRAM) device, a static random access memory (SRAM) device, Flash RAM (non-volatile storage), combinations of the above, or some other memory device known in the art. The memory 212 may include a vehicle communication module 214 and a database 216. The vehicle communication module 214 may be adapted to communicate with the processor 202, the input device 204, the output device 206, the transceiver device 208, and/or the position detection device 210.

The database 220 may be used for storing trip information including stop locations. Routes and patterns may also be stored in the database 220. This information may be stored on the vehicle 102, on the personal device, remote from the vehicle 102, or a combination thereof. The trip information may be detailed or not. For example, simple trip information may indicate stops for the vehicle 102 with coordinates of those stops. More detailed information such as routes or paths taken between the stops along with timing information may be stored or processed as trip information.

In one embodiment, the information may be uploaded or sent to the communication network 104. This may occur periodically such that the information is sent every ten (10) minutes the vehicle 102 is on. In some embodiments, the vehicle 102 may upload information to the vehicle production and distribution system 106 when the ignition is turned on. Other configurations exist and are not limited to those described above.

Trip information may be tagged and stored in the database 216. This information may include when the vehicle 102 stops, for example, when the driver places the vehicle 102 in a park position using their gear shifter. In one embodiment, a stop may be made when the vehicle is going zero (0) mph without the gear shifter placed in park. Alternatively, when the vehicle 102 has stopped for a predefined period of time, for example, one (1) minute, then the location may be tagged as a stop. This information may be stored. In some implementations, the routes or paths that were taken may also may be stored in the database 216 of the vehicle 102. This may be stored locally and/or remotely from the vehicle 102. The routes or paths may be determined by tracking the vehicle 102 in real time. This may require the use of retrieving information periodically or constantly.

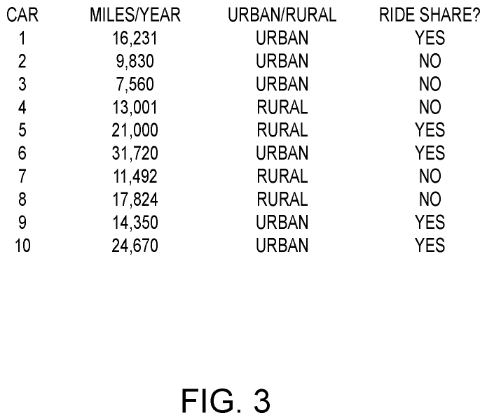

A number of different factors may be used to determine whether the vehicle 102 is being used for a ride share program. FIG. 3 is a schematic diagram of an illustrative table showing miles per year for a plurality of vehicles 102 within an urban and rural environment to determine whether the vehicles 102 are in a ride share program in accordance with one aspect of the present disclosure. Miles per year may be one of many factors to determine whether the vehicle 102 is in a ride share program.

The vehicle production and distribution system 106 may implement a number of different algorithms or routines to determine whether the vehicles 102 are in a ride share program. For example, and as shown, the system 106 may distinguish when the vehicle 102 is driven in an urban or rural environment. Locations, possibly obtained from GPS coordinates described above, may be matched with designated urban or rural environments. The system 106 may then set a threshold of how many miles are typically drive in the urban or rural environment.

In one embodiment, and to determine whether the vehicle 102 is in an urban or rural environment, the system 106 may determine how many miles are driven between stopping locations. In a more rural area, as the system 106 would recognize, more miles are being driven between stops. Oppositely, in urban areas, less miles may be driven between stops. If a mixture of both occurs, that is where stops vary between a large or small amount of miles, the vehicle 102 may be determined to travel in urban and rural areas.

For determining whether the vehicle 102 is in a ride share program, the system 106 may associate with the urban and rural environments a mileage threshold. When the vehicle 102 surpasses the threshold, the vehicle 102 may be designated as in a ride share program. In one embodiment, and in accordance with the algorithm shown, a vehicle 102 may be classified as being part of a ride share program when the miles for the vehicle 102 are above twelve thousand (12,000) in an urban environment. If the miles per year for the vehicle 102 are below twelve thousand (12,000), then the vehicle 102 may be associated as a personal use vehicle 102 or not in a ride-share program.

In the illustration, cars 1, 2, 3, 6, 9, and 10 have been determined to be within urban environments. Using the algorithm or logic above, the vehicle production and distribution system 106 may determine that cars 1, 6, 9, and 10 are within a ride share program because they are urban vehicles 102 and they have yearly mileage above twelve thousand (12,000). Cars 2 and 3, also designated as urban vehicles 102, have yearly mileage lower than twelve thousand (12,000) and may be associated as not in a ride share program.

Cars 4, 5, 7, and 8 may be detected as vehicles 102 in a rural environment. The algorithm may determine that a vehicle 102 is in a ride share program if the yearly miles is more than eighteen thousand (18,000). If the yearly miles are below eighteen thousand (18,000), then the vehicle 102 may be associated as a personal use vehicle and not in a ride share program. In the illustration, cars 4, 7, and 8 are not in a ride share program as each of their yearly miles are under eighteen thousand (18,000). Car 5 may be designated as in a ride share program as it has yearly mileage of over eighteen thousand (18,000).

In one embodiment, a vehicle 102 may be in both an urban and rural environment. Stopping locations may indicate that the vehicle 102 travels between both. The threshold for determining whether the vehicle 102 is in a ride share program may be fifteen thousand (15,000). That is, if a vehicle 102 has been detected above the threshold, then the vehicle 102 may be associated with a ride share program and if below, then labelled as a personal use vehicle 102.

A number of different variations may exist. For example, in larger cities, the miles per year may be lowered to determine whether a vehicle 102 is in a ride share program. The geographic area that the vehicle 102 is determined to be in may be used to take into account average yearly miles driven by those who are in a ride share program and those who are not. For example, someone in Chicago may drive less miles than someone who is in San Francisco, both of which are in urban environments. Other algorithms may not take the yearly mileage. Rather, the system 106 may use quarterly or half a year system to determine whether the mileages are above or below a threshold.

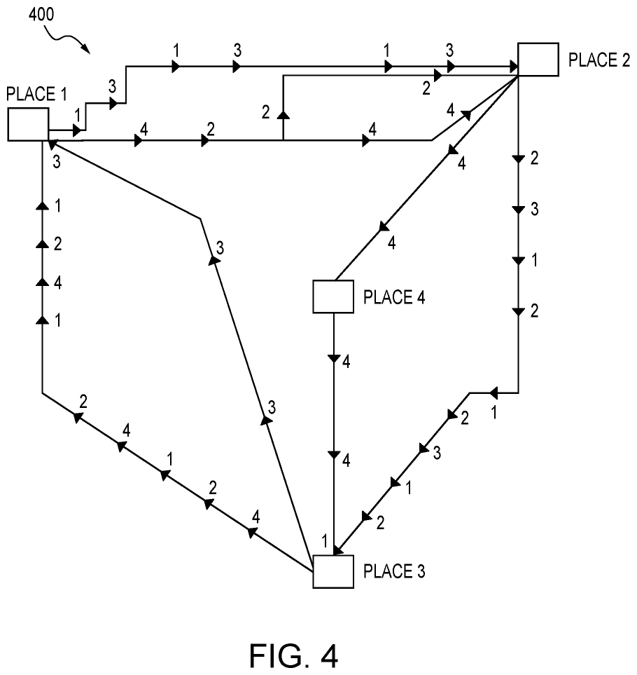

Another factor that may be determinative of whether a vehicle 102 is in a ride share program may be patterns identified by trip information. In identifiable consistent patterns, the vehicle 102 may be more likely associated with a personal use vehicle and not in a ride share program. FIG. 4 is a schematic diagram of an illustrative vehicle 102 showing routes taken by the vehicle 102 that may demonstrate that the vehicle 102 is not in a ride share program in accordance with one aspect of the present disclosure. In this scenario 400, a number of routes are taken by the vehicle 102 and are shown with different trip information.

For the 1^{st} Path, the vehicle 102 may traverse from Place 1 to Place 2. Place 1 may be the initial starting point for the vehicle 102, such as a driver's home. A route familiar with the driver may be taken between Place 1 and Place 2. At Place 2, the vehicle 102 may stop for a period of time which is above a predefined threshold that indicates that this is not a ride share drop off or pick up. That is, the stop may be for more than five (5) minutes.

The vehicle 102, still on the same day, may then travel from Place 2 to Place 3. Another familiar route may be taken. Similar to Place 2, the vehicle 102 may have stopped at Place 3 for a period of time that is longer than the predetermined threshold that would indicate that the vehicle 102 is not in a ride share program. The vehicle 102 may then go from Place 3 to Place 1.

On a second day, a 2^{nd} Path may be taken. The vehicle 102 may take a different route from Place 1 to Place 2. A different route or path may be taken as a result of traffic. Again, the driver of the vehicle 102 may stop at Place 2 for a period of time above the predetermined threshold. Following, the 2^{nd} Path may be similar to the 1^{st} Path between Place 2 and Place 3. The route taken from Place 3 to Place 1 may be the same. As shown, the 1^{st} Path may be similar to the 2^{nd} Path.

On a third day, a 3^{rd} Path may be taken. The vehicle 102 may take a similar route as in the 1^{st} Path from Place 1 to Place 2. The vehicle 102 may stay at Place 2 for a period of time above the predetermined threshold. The 3^{rd} Path may have the same route between Place 2 and Place 3 as the 1^{st} and 2^{nd} Paths. The driver may stay at Place 3 above the predetermined threshold. The 3^{rd} Path from Place 3 to Place 1, however, may take a different route. This may be the result of traffic or other type of congestion.

On a fourth day, a 4^{th} Path may be taken. From Place 1 to Place 2, the 4^{th} Path may deviate from the other Paths taken earlier. This may be a result of traffic or other type of congestion. Again, the vehicle 102 may stay at Place 2 for a period of time above the predetermined threshold. Deviating, however, the 4^{th} Path may go to a new place, Place 4. This may be, for example, a grocery store of pharmacy. Thereafter, the 4^{th} Path goes to Place 3 and then Place 1, using similar routes described in the earlier Paths.

As shown above, the vehicle 102 traveled on different Paths. These Paths may have consistently been visited Places and used frequently taken routes. Through this information, regular patterns may be identified. For example, Place 2 and Place 3 may be visited more frequently, as it is suggested. Because of this, and the regularity of the patterns, the vehicle production and distribution system 106 may then associate this vehicle 102 as a personal use vehicle or not in a ride share program.

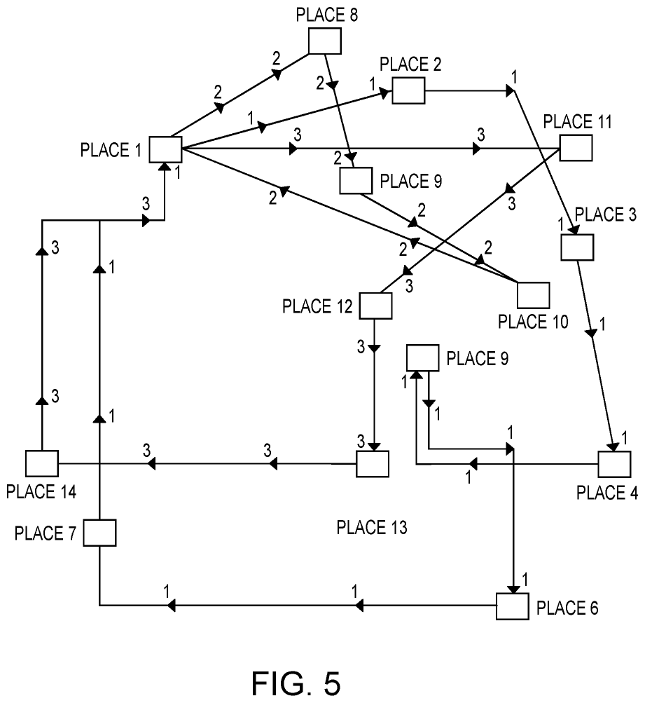

FIG. 5 is a schematic diagram of an illustrative vehicle 102 showing routes taken by the vehicle 102 that may demonstrate that the vehicle 102 is in a ride share program in accordance with one aspect of the present disclosure. The vehicle 102 may begin on the first day taking the 1^{st} Path. The vehicle 102 may traverse from Place 1 to Place 2 then to Place 3 and Place 4. Following, the vehicle still on the 1^{st} Path may travel to Place 5, 6, and 7. The vehicle 102 may then return back to Place 1.

On a second day, a 2^{nd} Path may be taken. Noticeably, however, the same Places are not visited. The vehicle 102 may initially go to Place 8, followed by Place 9, and then to Place 10. The vehicle 102 may then return back to Place 1.

On a third day, a 3^{rd} Path may be taken. The vehicle 102 may begin at Place 1 and then go to Place 11. Following, the vehicle 102 may go to Place 12, 13 and 14. The vehicle then may return to Place 1.

Noticeably, after Place 1, there is no consistent or frequently visited Place. Rather, each of the Places are diverse and separate from one another. The Places were also visited less than a predetermined threshold of time. This may be less than five (5) minutes. Typically, the driver in a ride share program may stay less than the five (5) minutes to pick up and/or drop off passengers. Through this pattern, the vehicle production and distribution system 106 may determine that the vehicle 102 is in a ride share program.

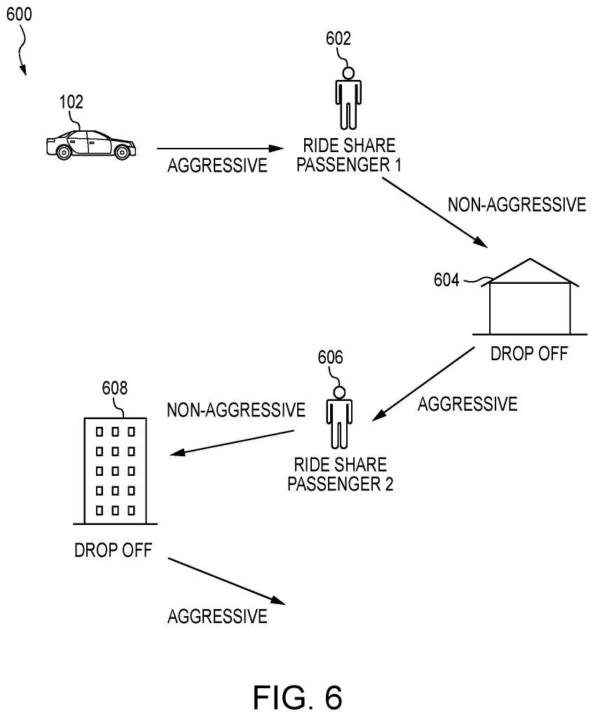

Another factor that may be used to determine whether a vehicle 102 is in a ride share program is determining aggressive driving patterns. Aggressive driving patterns may be determined through the monitoring of vehicle data. For example, the vehicle data may indicate periods of acceleration, velocity and brake presses. FIG. 6 is a schematic diagram of an illustrative vehicle 102 showing aggressive and non-aggressive behavior taken by the vehicle 102 that may demonstrate that the vehicle 102 is in a ride share program in accordance with one aspect of the present disclosure. Often times in ride share programs, a driver is given a rating on their driving. This rating may be affected by their driving style, i.e., whether they are aggressive or not.

In this scenario 600, the vehicle 102 may receive a pick up request from a 1^{st} Passenger 602. To get there, the driver of the vehicle 102 aggressively travels to the pickup location of the Passenger 602. During the drive, after picking up the 1^{st} Passenger 602, the driver drives with caution and courteousness to get a higher rating for the ride share program.

After the driver drops off the 1^{st} Passenger at a 1^{st} Place 604, the driver may get another request for a pickup of a 2^{nd} Passenger 606. The driver of the vehicle 102 may then travel aggressively to pick up the 2^{nd} Passenger 606. After pickup, the driver displays again non-aggressive driving behavior to receive a higher rating from the 2^{nd} Passenger 606. The driver of the vehicle 102 may then drop off the 2^{nd} Passenger 606 at a 2^{nd} Place. The driver may then drive aggressively to get to the next passenger.

Through the patterns described above within the scenario 600, certain styles of driving may indicate whether the vehicle 102 is part of a ride sharing program. Typically, the pattern involves aggressive driving followed by non-aggressive driving. Oppositely, in a non-ride share program, the vehicle 102 may be more likely to maintain their driving style. These patterns may be used to distinguish whether the vehicle 102 is in a ride share program or not.

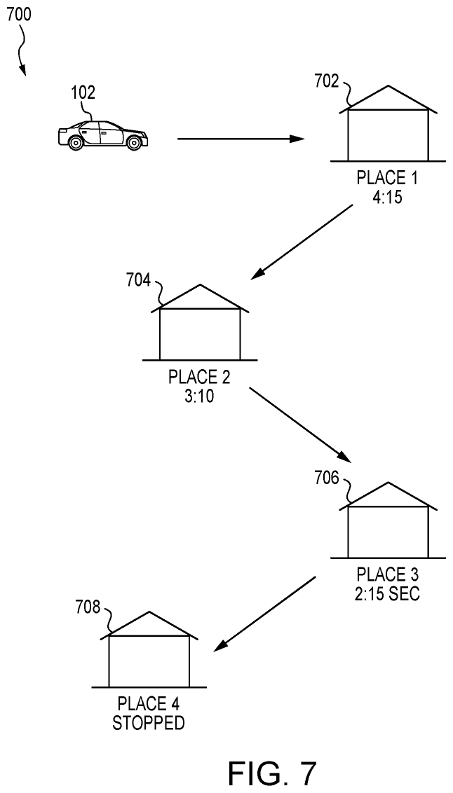

Time spent at a place may also be a factor in determining whether the vehicle 102 is part of a ride share program. Typical ride share programs may allow five (5) minutes for a passenger to get to the vehicle 102 before the driver may take off. FIG. 7 is a schematic diagram of an illustrative vehicle 102 showing time taken at different stops that may demonstrate that the vehicle 102 is in a ride share program in accordance with one aspect of the present disclosure. Stops, as described earlier, may be defined as where the vehicle 102 has no acceleration or velocity. Additionally or alternatively, a stop may be defined as where the driver has placed their vehicle 102 into “park” through their shifter.

In this scenario 700, the vehicle 102 may stop at a 1^{st} Place 702. The vehicle 102 may stop at the 1^{st} Place 702 for four (4) minutes and fifteen (15) seconds. Because this may be below the predetermined threshold of five (5) minutes, the vehicle production and distribution system 106 may determine that this vehicle 102 may be in a ride share program.

At a 2^{nd} Place 704, the vehicle stops for three (3) minutes and ten (10) seconds. At a 3^{rd} Place 706, the vehicle 102 is at the location for two (2) minutes and fifteen (15) seconds. The vehicle thus stays at each of these places less than the predetermined threshold of five (5) minutes. Because of this, the vehicle 102 may be classified or associated with a ride share program. The vehicle 102 may then go to a 4^{th} Place where it stops for a longer period of time.

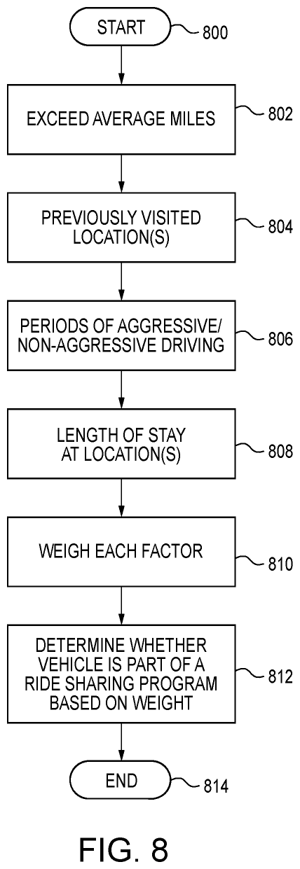

FIG. 8 is a schematic diagram of an illustrative flow chart showing factors that may be used to determine whether a vehicle 102 is in a ride share program in accordance with one aspect of the present disclosure. The factors may be representative but are not intended to show that all of them are required to determine whether the vehicle 102 is in a ride share program. That is, a portion of the factors may be used to determine whether the vehicle 102 is in a ride share program.

The processes may begin at block 800. Information as described earlier is provided to the vehicle production and distribution system 106. This information may include stopping locations and/or routes. Vehicle data may also be provided. At block 802, the system 106 may determine whether the vehicle 102 has exceeded the average miles for the geographic area. As provided earlier, the system 106 may determine whether the vehicle 102 is in an urban or rural environment and set a threshold for miles which when exceeded, the vehicle 102 may be associated with a ride share program. Geographic areas in which average miles per year that have been established may be taken into account of. For example, urban environments may be able to distinguish different cities and the amount of miles that a driver uses within a ride share program or not.

At block 804, the vehicle production and distribution system 106 may determine whether patterns may have been established by the stopping locations and the routes taken. Typically, previously visited locations may be determinative of whether the vehicle 102 is in a ride share program. Those drivers who work with ride share programs rarely stop at the same place throughout their day, while oppositely, drivers who are not in a ride share program frequently visit the same places.

At block 806, the vehicle production and distribution system 106 may determine whether there are periods of aggressive/non aggressive driving. As explained above, and because of how drivers are rated, the driver of the vehicle 102 in a ride share program are less likely to drive aggressively when a passenger has been picked up. A driver within a ride share program may drive more aggressive when trying to pick up a passenger. These periods of aggressive and non-aggressive driving may thus indicate that the driver is part of a ride share program.

At block 808, the vehicle production and distribution system 106 may determine the length of stay at locations to determine whether the vehicle 102 is in a ride share program. Depending on how long the vehicle 102 stays at a location, the system 106 may associate it to a ride share program. Typically, the driver is not likely to stay more than five (5) minutes waiting for a passenger pickup and thus, by monitoring how long the vehicle 102 has stayed at a place, a determination may be made on whether the vehicle 102 is in a ride share program.

At block 810, the factors presented above may be given a weight. That is, a weighing factor may be tied to each of the blocks described above. For example, when average miles are exceed this may be given a higher weight than the length of stay at locations. In one embodiment, irregular driving patterns may be given the highest weight. At block 812, the vehicle 102 is determined to be in a ride share program or not based on the weighing of the factors described above. The processes may end at block 814.

By determining whether the vehicle is in a ride share program, future production needs may be determined. The vehicle production and distribution system 106 may aggregate the information and determine the numbers of vehicles 102 that may be used in the future for ride share programs as well as those vehicles 102 that are used for personal uses. This information may then be provided to the factories 108 where vehicles 102 may be made. These vehicles 102 may then be distributed to dealerships 110. While these vehicles 102 may not be used by those providing the information, the factories 108 may ensure that the numbers of vehicles 102 for ride share programs are in line with other customer's needs or requirements. In one embodiment, factories 108 or dealerships 110 may be able to customize the vehicles 102 based on specific geographical needs.

In one implementation, the location information gathered from the vehicles 102 may also be used to distribute those new vehicles 102 to localized dealerships 110. The trip information from the vehicles 102 may be used to determine where vehicles are being used in ride share programs. Through this information, distribution of the vehicles 102 may be made to dealerships 110 where those vehicles 102 traveled around.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A vehicle production system comprising:
a communication network;
at least one processor; and
a memory operatively coupled to the processor, the memory storing program instructions that when executed by the processor, causes the processor to:
receive locations of stops from a plurality of vehicles through the communication network;
identify patterns through the locations of the stops for the plurality of vehicles;
determine whether vehicles within the plurality of vehicles are for ride share based on the patterns;
produce a number of new vehicles for ride share based on the determination.

2. The vehicle production system of claim 1, wherein receiving the locations of the stops from the plurality of vehicles through the communication network comprises uploading information from a transmission control unit or smart device associated with the plurality of vehicles.

3. The vehicle production system of claim 1, wherein receiving the locations of stops from the plurality of vehicles through the communication network comprises uploading information when the plurality of vehicles are set to ignition on.

4. The vehicle production system of claim 1, wherein identifying patterns through the locations of the stops comprises identifying previously visited or new locations.

5. The vehicle production system of claim 4, wherein determining whether the vehicles within the plurality of vehicles are for ride share based on the patterns comprises associating vehicles that stop at previously visited locations as non-ride share and vehicles that stop at new locations as ride share.

6. The vehicle production system of claim 1, wherein producing the number of new vehicles for ride share based on the determination comprises determining a ratio for ride share vehicles to non-ride share vehicles.

7. A method of identifying a ride share vehicle comprising:
determining locations of stops for a vehicle; and
associating the vehicle as a ride share vehicle when the locations of the stops for the vehicle are irregular and a time at the stops are below a predetermined threshold.

8. The method of identifying the ride share vehicle of claim 7, wherein the predetermined threshold is five (5) minutes.

9. The method of identifying the ride share vehicle of claim 7, wherein the stops for the vehicle are irregular if the stops have not been visited over a predetermined time.

10. The method of identifying the ride share vehicle of claim 9, wherein the predetermined time is six (6) months.

11. The method of identifying the ride share vehicle of claim 7, wherein associating the vehicle as the ride share vehicle comprises determining miles driven each year for the vehicle.

12. The method of identifying the ride share vehicle of claim 11, comprises determining whether the vehicle is in an urban or rural environment.

13. The method of identifying the ride share vehicle of claim 7, wherein associating the vehicle as the ride share vehicle comprises identifying periods of aggressive and non-aggressive driving behavior between stops.

14. The method of identifying a ride share vehicle of claim 7, comprising providing whether the vehicle is a ride share vehicle to a vehicle production system.

15. A vehicle production and distribution system comprising:
a plurality of vehicles providing locations of stops; and
a server receiving the locations of the stops for the plurality of vehicles and associating the plurality of vehicles as ride share vehicles when the locations of the stops are irregular and a time at the stops are below a predetermined threshold, the server taking ratios of ride share vehicles to non-ride share vehicles and generating production schedules.

16. The vehicle production and distribution system of claim 15, wherein new ride share vehicles are distributed to dealerships around the locations of the stops that are irregular.

17. The vehicle production and distribution system of claim 15, wherein the predetermined threshold is five (5) minutes.

18. The vehicle production and distribution system of claim 15, wherein the plurality of vehicles provide the locations of the stops through a transmission control unit or smart device.

19. The vehicle production and distribution system of claim 15, wherein associating the plurality of vehicles as ride share vehicles comprises identifying periods of aggressive and non-aggressive driving behavior between stops.

20. The vehicle production and distribution system of claim 15, wherein associating the plurality of vehicles as ride share vehicles comprises determining miles driven each year for the plurality of vehicles.
